(19) United States
(12) Patent Application Publication
(10) Pub. No.: US 2016/0254524 A1
(43) Pub. Date: Sep. 1, 2016

(54) ROTARY SCREEN PLATE AND METHOD OF MANUFACTURING SECONDARY BATTERY

(71) Applicant: TOYOTA JIDOSHA KABUSHIKI KAISHA, Toyota-shi, Aichi (JP)

(72) Inventor: Nobuyuki YAMAZAKI, Toyota-shi (JP)

(73) Assignee: TOYOTA JIDOSHA KABUSHIKI KAISHA, Toyota-shi, Aichi (JP)

(21) Appl. No.: 15/028,544

(22) PCT Filed: Oct. 22, 2014
(86) PCT No.: PCT/JP2014/005352

§ 371 Date: Apr. 11, 2016

(30) Foreign Application Priority Data
Nov. 22, 2013 (JP) 2013-242173

(51) Int. Cl. H01M 4/04; H01M 4/62; H01M 4/525; H01M 4/505; H01M 4/131; H01M 4/1391

(52) U.S. Cl. CPC H01M 4/0414; H01M 4/0404; H01M 4/131; H01M 4/1391; H01M 4/525; H01M 4/505; H01M 4/623; H01M 4/625; H01M 2004/028

(57) ABSTRACT

A rotary screen plate 100 that is a cylindrical body including a plurality of injection holes 11 through which electrode mixture paste is injected to a collector from inside the cylindrical body in an outer peripheral surface of the cylindrical body. The rotary screen plate includes a projection 12 that projects outwardly of the cylindrical body further than another part of the outer peripheral surface 1 on the outer peripheral surface 1 of the cylindrical body. The projection 12 creates a moderate gap between the collector and the outer peripheral surface 1, and thus even the electrode mixture paste with a high content of powder and high viscosity can sufficiently spread over the part of the outer peripheral surface 1 of the rotary screen plate 100 other than the injection holes 11. The electrode mixture paste can be applied to the collector with a uniform film thickness.

### TECHNICAL FIELD

The present invention relates to a rotary screen plate and a method of manufacturing a secondary battery.

### BACKGROUND ART

An electrode body of a secondary battery is obtained by applying electrode mixture paste to a collector (an electrode substrate) and winding the collector. The electrode mixture paste applied to the collector is manufactured by kneading powder such as an active material, a binder, and a conductive aid and a solvent. Further, the electrode mixture paste is applied to the collector by, for example, rotary screen printing or the like.

For example, Patent Literature 1 discloses a rotary screen plate that applies electrode mixture paste to a collector. The rotary screen plate disclosed in Patent Literature 1 is a cylindrical screen plate and includes, on an outer peripheral surface of the screen plate, a number of small holes through which the electrode mixture paste is pushed from the inside to the outside of the cylindrical screen plate. When the rotary screen plate rotates on the collector while pushing the electrode mixture paste from the small holes, the electrode mixture paste is applied to the collector.

After the electrode mixture paste is applied to the collector, the electrode mixture paste is dried. In order to reduce the cost of dry processing and materials for the electrode mixture paste, how to reduce an amount of the solvent used to produce the electrode mixture paste and how to increase a content of the powder in the electrode mixture paste have been investigated.

### CITATION LIST

### Patent Literature

Patent Literature 1: Japanese Unexamined Patent Application Publication No. 2002-164043

### SUMMARY OF INVENTION

### Technical Problem

However, when the content of the powder in the electrode mixture paste is increased, viscosity of the electrode mixture paste will become higher, thereby causing problems such that thin spots are generated in an electrode mixture layer formed on the collector and a film thickness of the electrode mixture layer becomes non-uniform.

To be more specific, as a part of the outer peripheral surface of the rotary screen plate disclosed in Patent Literature 1 other than the small holes is a flat and smooth surface, the part of the outer peripheral surface of the rotary screen plate other than the small holes is firmly attached to a surface of the collector. Accordingly, when the electrode mixture paste with high viscosity is applied using the rotary screen plate disclosed in Patent Literature 1, the electrode mixture paste will not spread over the part of the outer peripheral surface of the rotary screen plate other than the small holes, thin spots could be generated in the electrode mixture layer formed on the collector, and the film thickness of the electrode mixture layer could become non-uniform. This causes problems such that an amount of the electrode mixture paste applied to the collector will be insufficient and Li will be deposited.

The present invention has been made in order to solve such problems and an object of the present invention is to provide a rotary screen plate that can apply electrode mixture paste to a collector with a uniform film thickness and a method of manufacturing a secondary battery.

### Solution to Problem

A first exemplary aspect of the present invention is a rotary screen plate that is a cylindrical body including, in an outer peripheral surface of the cylindrical body, a plurality of injection holes through which printing paste is injected to a printed substrate from inside the cylindrical body. The rotary screen plate includes a projection that projects outwardly of the cylindrical body further than another part of the outer peripheral surface on the outer peripheral surface of the cylindrical body.

According to the rotary screen plate of the first exemplary aspect of the present invention, the projection projecting outwardly of the cylindrical body further than the other part of the outer peripheral surface of the cylindrical body creates a moderate gap between the printed substrate and the outer peripheral surface of the rotary screen plate, and thus even the printing paste with high viscosity can sufficiently spread over the part of the outer peripheral surface of the rotary screen plate other than the injection holes. Therefore, the printing paste can be applied to the printed substrate with a uniform film thickness. In other words, electrode mixture paste as the printing paste can be applied to a collector as the printed substrate with a uniform film thickness.

A second exemplary aspect of the present invention is a rotary screen plate that is a cylindrical body including, in an outer peripheral surface of the cylindrical body, a plurality of injection holes through which electrode mixture paste is injected to a collector from inside the cylindrical body. The rotary screen plate includes a projection that projects outwardly of the cylindrical body further than another part of the outer peripheral surface on the outer peripheral surface of the cylindrical body.

According to the rotary screen plate of the second exemplary aspect of the present invention, the projection projecting outwardly of the cylindrical body further than another part of the outer peripheral surface of the cylindrical body creates a moderate gap between the collector and the outer peripheral surface of the rotary screen plate, and thus even the electrode mixture paste with a high content of powder and high viscosity can sufficiently spread over the part of the outer peripheral surface of the rotary screen plate other than the injection holes. Therefore, the electrode mixture paste can be applied to the collector with a uniform film thickness.

A third exemplary aspect of the present invention is a method of manufacturing a secondary battery including an application step for applying electrode mixture paste to a collector using a rotary screen plate that is the cylindrical body including the projection that projects outwardly of the cylindrical body further than the other part of the outer peripheral surface on the outer peripheral surface of the cylindrical body.

According to the method of manufacturing the secondary battery of the third exemplary aspect of the present invention, it is possible to apply the electrode mixture paste to the collector with a uniform film thickness.

### Advantageous Effects of Invention

It is possible to provide a rotary screen plate that can apply electrode mixture paste to a collector with a uniform film thickness and a method of manufacturing a secondary battery.

### BRIEF DESCRIPTION OF DRAWINGS

FIG. 1 is a perspective diagram for explaining a rotary screen plate according to a first exemplary embodiment of the present invention;

FIG. 2 is a perspective diagram for explaining a method of manufacturing the rotary screen plate according to the first exemplary embodiment of the present invention;

FIG. 3 is a drawing for explaining examples 1 and 2 and a comparative example 1;

FIG. 4 is a table for explaining results in which electrode mixture paste is applied to collectors using rotary screen plates according to the example 1 and the comparative example 1;

FIG. 5 is a graph for explaining results in which the electrode mixture paste is applied to the collectors using the rotary screen plates according to the example 1 and the comparative example 1;

FIG. 6 is a perspective diagram for explaining the rotary screen plate according to the comparative example 1;

FIG. 7 is a cross-sectional diagram for explaining a relationship between contact between a collector and a plate and a film thickness of an electrode mixture layer formed on the collector; and

FIG. 8 is a cross-sectional diagram for explaining a relationship between contact between the collector and a plate and a film thickness of the electrode mixture layer formed on the collector.

### DESCRIPTION OF EMBODIMENTS

### First Exemplary Embodiment

Hereinafter, a first exemplary embodiment of the present invention will be explained with reference to the drawings. A rotary screen plate 100 according to the first exemplary embodiment of the present invention applies electrode mixture paste (a printing paste) to a collector (a printed substrate).

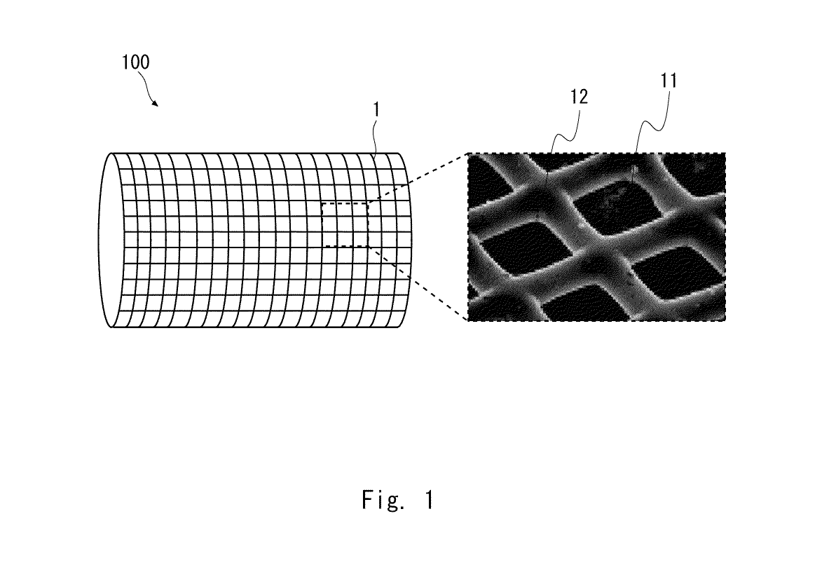

FIG. 1 is a perspective diagram for explaining the rotary screen plate 100 according to the first exemplary embodiment of the present invention. A photograph on the right side of FIG. 1 shows an enlarged view of a part of the rotary screen plate 100. This photograph has been obtained by imaging the rotary screen plate 100 by a scanning electron microscope. As shown in FIG. 1, the rotary screen plate 100 has a plurality of injection holes 11 on an outer peripheral surface 1 of a cylindrical body. The electrode mixture paste is injected from inside the cylindrical body to the collector through the injection holes 11.

The rotary screen plate 100 further includes, on the outer peripheral surface 1 of the cylindrical body, projections 12 that project outwardly of the cylindrical body further than another part of the outer peripheral surface 1. To be more specific, the rotary screen plate 100 is a mesh (a net) having a shape of the cylindrical body. The projections 12 are formed at intersections of wires constituting the mesh. In other words, the projections 12 are regularly present on the outer peripheral surface 1 of the rotary screen plate 100. Further, the injection holes 11 are composed of mesh openings.

The rotary screen plate 100 further includes a squeegee or the like (not shown) that pushes the electrode mixture paste pumped inside the cylindrical body from the injection holes 11.

Then, the rotary screen plate 100 rotates on the collector while the electrode mixture paste is flowing out from the injection holes 11 of the rotary screen plate 100. In this way, the electrode mixture paste is applied to the collector.

Moreover, the rotary screen plate 100 is electroformed.

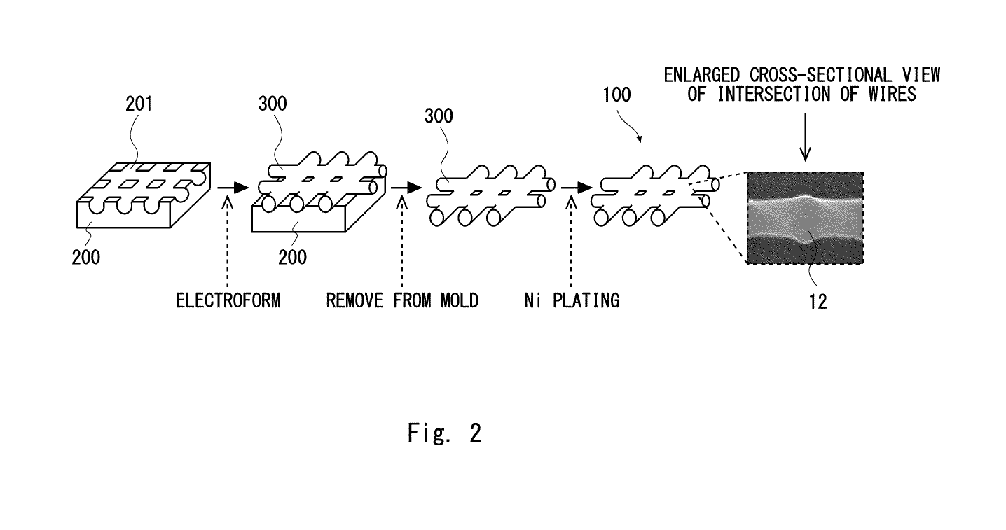

Next, a method of manufacturing the rotary screen plate 100 according to the first exemplary embodiment of the present invention will be explained by referring to FIG. 2. FIG. 2 is a drawing showing an enlarged view of a part of an electroformed mold 200, a mesh 300, and the rotary screen plate 100. Further, the photograph on the right side of FIG. 2 is a cross-sectional photograph obtained by imaging the intersections of the wires of the rotary screen plate 100 by the scanning electron microscope.

Firstly, as shown in FIG. 2, electroforming is performed using the electroformed mold 200 having a cylindrical shape, and stainless steel (SUS) is electrodeposited on the electroformed mold 200. Then, the mesh (the net) 300 having a cylindrical shape made of the stainless steel (SUS) is manufactured on the electroformed mold 200. Note that grooves 201 corresponding to the mesh 300 having the desired cylindrical shape are formed on a surface of the electroformed mold 200.

Next, the mesh 300 having the cylindrical shape is removed from the electroformed mold 200, and Ni plating (nickel plating) is applied to the mesh 300. The projections 12 are formed at the intersections of the wires constituting the mesh 300 by this Ni plating, and then the rotary screen plate 100 is manufactured. Note that an aperture width of each of the injection holes 11 of the rotary screen plate 100 is preferably 110 μm or less.

Next, a method of manufacturing a secondary battery using the rotary screen plate 100 according to the first exemplary embodiment will be explained.

Firstly, an active material, a binder, a conductive aid, a solvent and the like are kneaded using a kneader to create the electrode mixture paste (a kneading step).

Next, the electrode mixture paste is applied to the collector using the rotary screen plate 100 (an application step).

Note that after the application step according to the first exemplary embodiment of the present invention is carried out, a plurality of manufacturing steps such as a drying step, a winding step and the like are carried out to thereby manufacture a secondary battery.

As has been explained so far, in the rotary screen plate 100 and the method of manufacturing the secondary battery according to the first exemplary embodiment of the present invention, the projections 12 that project outwardly of the cylindrical body further than the other part of the outer peripheral surface 1 of the cylindrical body provides moderate gaps between the collector and the outer peripheral surface 1 of the rotary screen plate 100. This allows the electrode mixture paste having a high content of powder and high viscosity to sufficiently spread over the part of the outer peripheral surface 1 of the rotary screen plate 100 other than the injection holes 11. Therefore, the electrode mixture paste can be applied to the collector with a uniform film thickness.

In particular, the projections 12 are regularly present on the outer peripheral surface 1 of the rotary screen plate 100. This prevents the thin spots of the electrode mixture paste which will be applied to the collector from being generated on the entire plate surface of the rotary screen plate 100.

Further, the rotation of the rotary screen plate 100 forces the rotary screen plate 100 to move away from the collector.

As the rotary screen plate 100 is electroformed, there is no joint in the rotary screen plate 100. Thus, when the rotary screen plate 100 rotates, the electrode mixture paste can be continuously applied to the collector.

Further, as the rotary screen plate 100 can be manufactured without using etching or laser beam machining, there will be less damage to the plate as compared to a rotary screen plate obtained by forming through-holes in a seamless roll by etching or laser beam machining.

Note that the electrode mixture layer may be uniform enough so that no inconvenience is caused in the performance of the electrode mixture layer and may not be completely uniform. That is, the film thickness of the electrode mixture layer applied to the collector by the rotary screen plate 100 according to the present invention may not be completely uniform. As the solvent is present immediately after the application of the electrode mixture layer, the uniformity of the film thickness of the electrode mixture layer can be visually confirmed. For example, when a printed substrate surface (a surface of the collector) can be seen within a range where the electrode mixture layer has been applied, the film thickness of the electrode mixture layer is evaluated as being non-uniform.

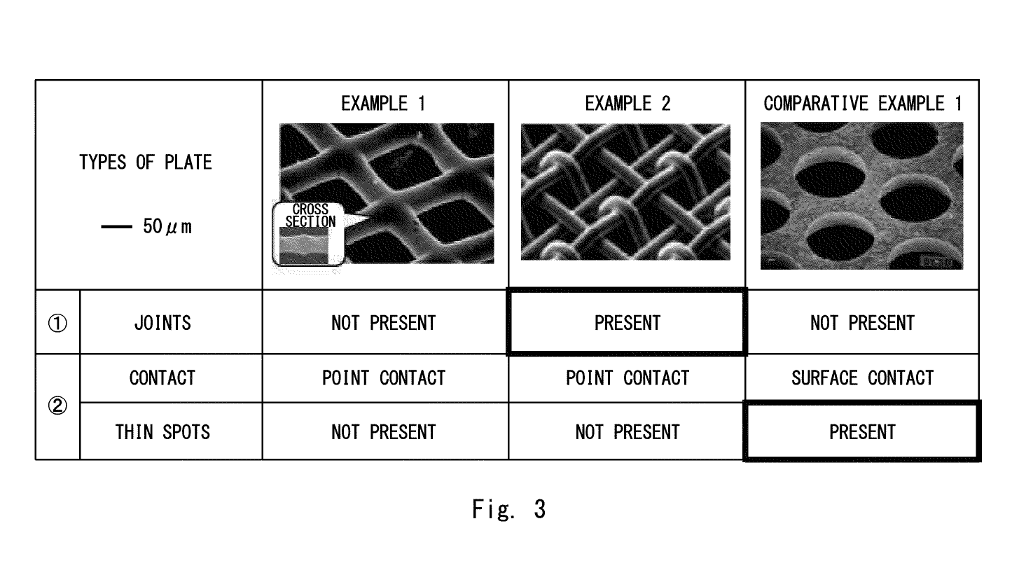

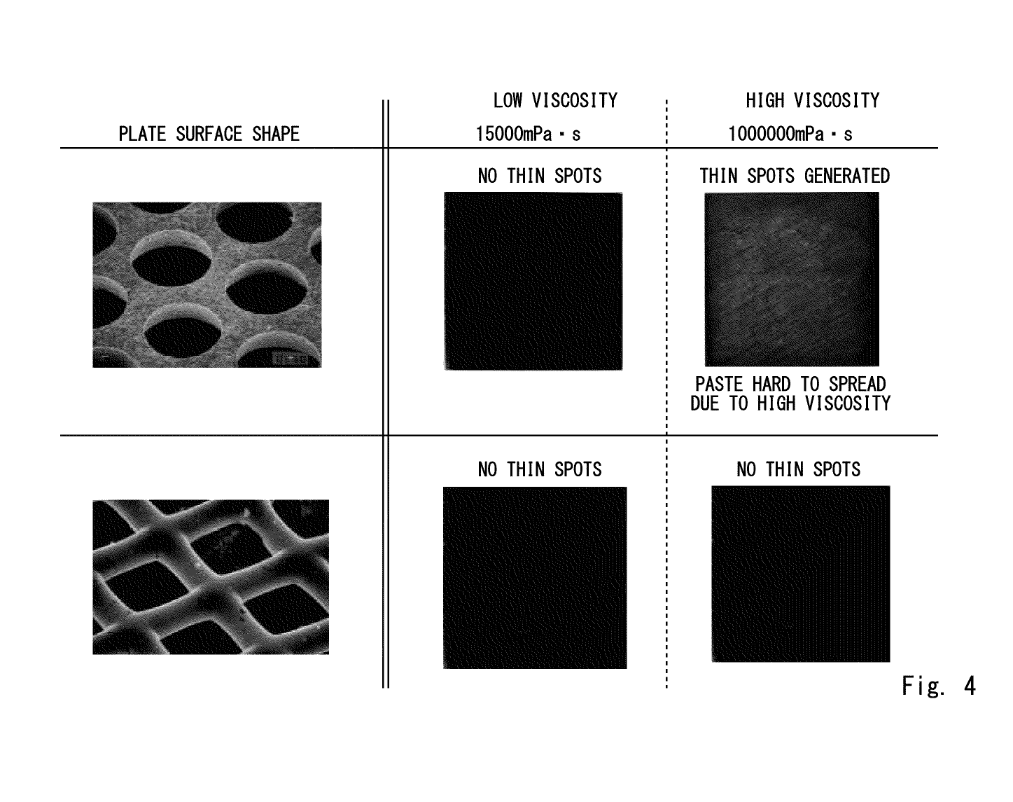

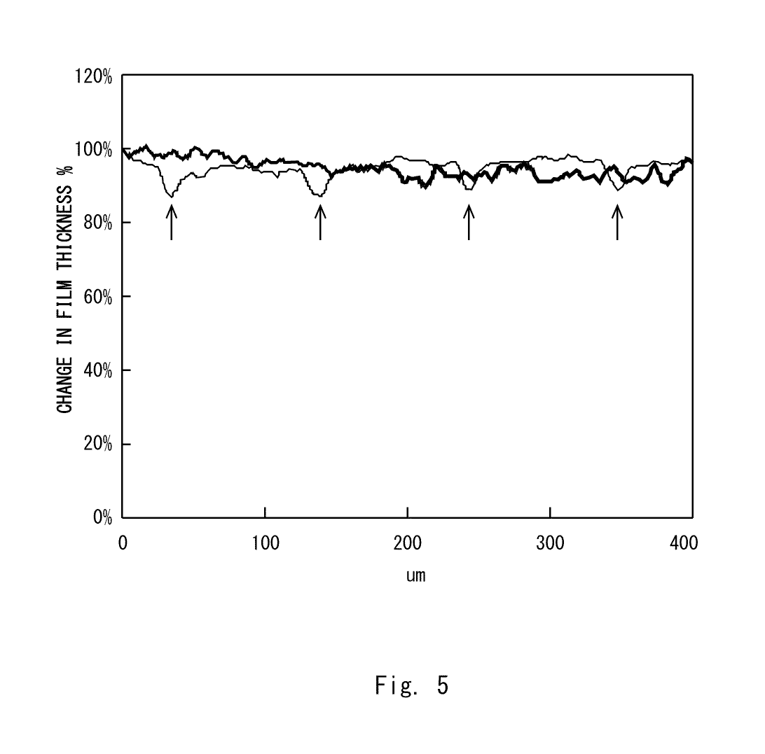

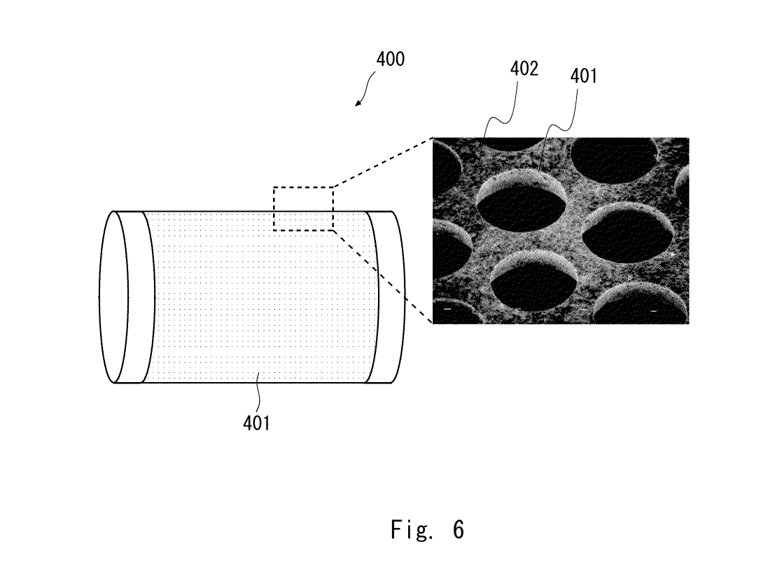

Next, examples 1 and 2 and a comparative example 1 will be explained by referring to FIGS. 3 to 6. FIG. 3 is a table for explaining the examples 1 and 2 and the comparative example 1. FIG. 4 is a table for explaining results in which the electrode mixture paste was applied to collectors using the rotary screen plate 100 according to the example 1 and a rotary screen plate 400 according to the comparative example 1. FIG. 5 is a graph for explaining results in which the electrode mixture paste was applied to the collectors using the rotary screen plate 100 according to the example 1 and the rotary screen plate 400 according to the comparative example 1. FIG. 6 is a perspective diagram for explaining the rotary screen plate 400 according to the comparative example 1.

The photographs shown in FIG. 3 were obtained by imaging the rotary screen plate 100 according to the example 1, a rotary screen plate according to the example 2, and the rotary screen plate 400 according to the comparative example 1 by the scanning electron microscope.

The rotary screen plate 100 according to the example 1 is the rotary screen plate 100 according to the first exemplary embodiment of the present invention.

Further, an aperture width of each of the injection holes 11 of the rotary screen plate 100 according to the example 1 was 90 μm, and a diameter of each of the wires constituting the mesh was 40 μm. A height of each of the projections 12 projecting further than the other part of the outer peripheral surface 1 was 5 μm.

The rotary screen plate according to the example 2 was obtained by winding a mesh (a net) formed by knitting wires in a shape of a cylinder. In other words, the outer peripheral surface of the rotary screen plate according to the example 2 was formed in a mesh. Note that as the rotary screen plate according to the example 2 was formed by knitting the wires, the intersections of the wires project outwardly of the cylinder further than the other part. Moreover, as the rotary screen plate according to the example 2 was formed by winding the mesh in a cylindrical shape, there were joints in the rotary screen plate according to the example 2.

Further, a width of each of apertures (mesh openings) of the rotary screen plate according to the example 2 was 87 μm, and a diameter of each of the wires constituting the mesh was 40 μm. The number of wires per one inch of the rotary screen plate according to the example 2 was 200.

As shown in FIG. 6, the rotary screen plate 400 according to the comparative example 1 was obtained by forming a number of through holes 401 in a cylindrical seamless roll by etching or laser beam machining. Arithmetic average roughness Ra of an outer peripheral surface 402 of the rotary screen plate 400 was less than 1 μm. A diameter of each of the through holes 401 of the rotary screen plate 400 was 90 μm. Note that the seamless roll was formed of stainless steel.

Further, in the examples 1 and 2 and the comparative example 1, ternary cathode active material was used as the active material, polyvinylidene fluoride (PVDF) was used as a binder, acetylene black (AB) was used as the conductive aid, and N-methyl-2-pyrrolidone (NMP) was used as the solvent. The ternary cathode active material is a cathode active material including cobalt, nickel, manganese and the like.

Further, viscosity of the electrode mixture paste was 15 Pa·s (pascal seconds) or 1000 Pa·s (pascal seconds).

In the table shown in FIG. 3, a second row indicates as to whether or not the respective plates had joints, and a third row indicates as to whether or not the respective plates came into contact with the collectors with points (point contact) or with surfaces (surface contact).

Further, a fourth row of the table shown in FIG. 3 indicates as to whether or not thin spots were generated when the electrode mixture paste having viscosity of 1000 Pa·s is applied to the collectors.

As shown in FIG. 3, no thin spots were generated by the rotary screen plate 100 according to the example 1 and the rotary screen plate according to the example 2, while thin spots were generated by the rotary screen plate 400 according to the comparative example 1. In other words, the film thickness of the electrode mixture paste applied to the collector was comparatively uniform in the examples 1 and 2, while the film thickness of the electrode mixture paste applied to the collector was non-uniform in the comparative example 1.

Note that as the rotary screen plate according to the example 2 had joints, the electrode mixture paste could not be continuously applied to the collector.

In a first column of the table shown in FIG. 4, the upper photograph shows the rotary screen plate 400 according to the comparative example 1, and the lower photograph shows the rotary screen plate 100 according to the example 1. The photographs shown in the first column of FIG. 4 were obtained by imaging the rotary screen plate 400 according to the comparative example 1 and the rotary screen plate 100 according to the example 1 by the scanning electron microscope.

Further, a second column of the table shown in FIG. 4 shows photographs obtained by imaging a surface of the electrode mixture layer formed on the collector by an optical microscope when the electrode mixture paste having viscosity of 15 Pa·s was applied to the collector. Moreover, a third column of the table shown in FIG. 4 shows photographs obtained by imaging a surface of the electrode mixture layer formed on the collector by the optical microscope when the electrode mixture paste having viscosity of 1000 Pa·s was applied to the collector.

As shown in FIG. 4, when the electrode mixture paste having viscosity of 15 Pa·s and the electrode mixture paste having viscosity of 1000 Pa·s were applied to the collector by the rotary screen plate 100 according to the example 1, the film thickness of the electrode mixture layer was comparatively uniform.

On the other hand, when the electrode mixture paste having viscosity of 15 Pa·s was applied to the collector by the rotary screen plate 400 according to the comparative example 1, the film thickness of the electrode mixture layer was comparatively uniform, while when the electrode mixture paste having viscosity of 1000 Pa·s was applied to the collector, the film thickness of the electrode mixture layer was non-uniform. That is, the higher the viscosity of the electrode mixture paste, the more thin spots were generated in the rotary screen plate 400 according to the comparative example 1.

The vertical axis of the graph shown in FIG. 5 indicates a change (%) in the film thickness of the electrode mixture paste applied to the collector, and the horizontal axis indicates a length (μm) of a predetermined cross-section of the electrode mixture paste applied to the collector. Note that the change (%) in the film thickness of the electrode mixture paste applied to the collector was 100% at the position where the horizontal axis was 0 μm. In FIG. 5, a thick solid line indicates the example 1, and a thin solid line indicates the comparative example 1. FIG. 5 shows a change in the film thickness of the electrode mixture paste when the electrode mixture paste having viscosity of 1000 Pa·s was applied to the collector.

As shown in FIG. 5, when the electrode mixture paste was applied to the collector by the rotary screen plate 100 according to the example 1, the film thickness of the electrode mixture paste applied to the collector has not greatly changed. In other words, when the electrode mixture paste having viscosity of 1000 Pa·s was applied to the collector by the rotary screen plate 100 according to the example 1, the film thickness of the electrode mixture paste applied to the collector was comparatively uniform.

On the other hand, when the electrode mixture paste was applied to the collector by the rotary screen plate 400 according to the comparative example 1, the film thickness of the electrode mixture paste applied to the collector has changed by 10% to 15% (parts indicated by the arrows in FIG. 5) in some parts. In other words, when the electrode mixture paste having viscosity of 1000 Pa·s was applied to the collector by the rotary screen plate 400 according to the comparative example 1, the film thickness of the electrode mixture paste applied to the collector was non-uniform.

As shown in FIGS. 3, 4, and 5, when the electrode mixture paste having viscosity of 1000 Pa·s was applied to the collector by the rotary screen plate 100 according to the example 1 and the rotary screen plate according to the example 2, the film thickness of the electrode mixture paste applied to the collector was comparatively uniform. On the other hand, when the electrode mixture paste having viscosity of 1000 Pa·s was applied to the collector by the rotary screen plate 400 according to the comparative example 1, the film thickness of the electrode mixture paste applied to the collector was non-uniform.

This may be because in the rotary screen plate 100 according to the example 1 and the rotary screen plate according to the example 2, the outer peripheral surface 1 came into point contact with the collector, while in the rotary screen plate 400 according to the comparative example 1, the outer peripheral surface 402 came into surface contact with the collector. To be specific, when the outer peripheral surface 1 came into point contact with the collector, the electrode mixture paste sufficiently spread over the outer peripheral surface 1, while when the outer peripheral surface 402 came into surface contact with the collector, the electrode mixture paste did not sufficiently spread over the outer peripheral surface 402.

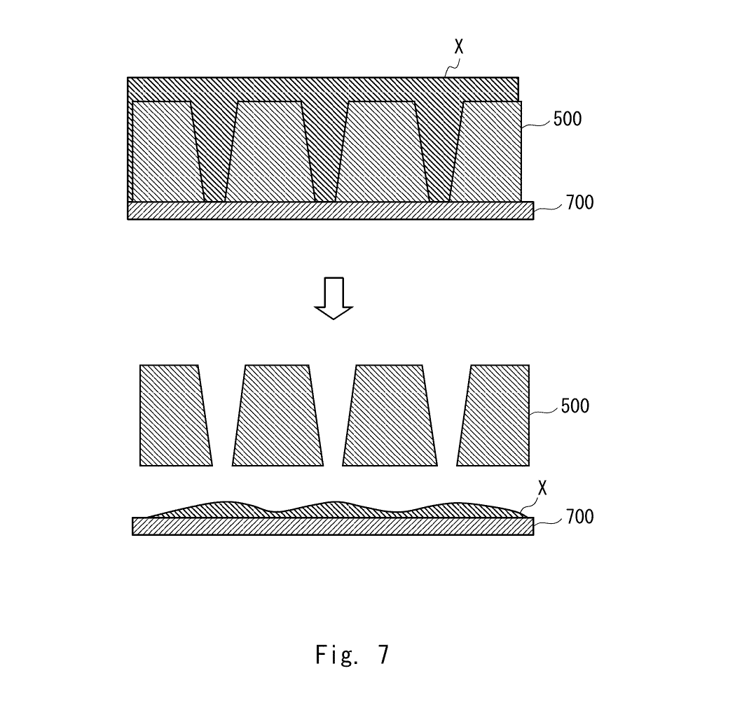

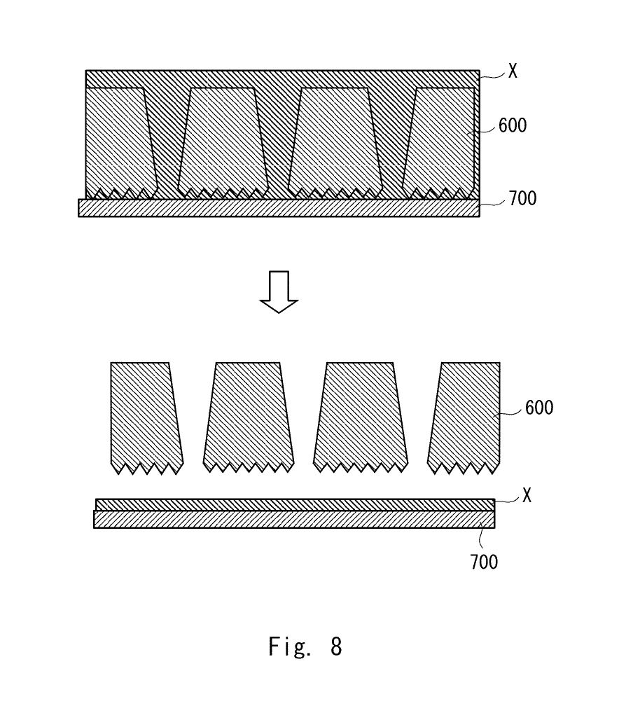

More specifically, a relationship between contact between the collector and the plate and the film thickness of the electrode mixture layer formed on the collector will be explained by referring to FIGS. 7 and 8. A surface of the plate 500 shown in FIG. 7 that comes into contact with a metallic foil (a collector) 700 (the surface shall be hereinafter referred to as a contacting surface) is a flat surface. On the other hand, a surface of a plate 600 shown in FIG. 8 that comes into contact with the metallic foil 700 (the surface hereinafter referred to as a contacting surface) is a surface having fine convexes and concaves.

In the plate 500 shown in FIG. 7, the contacting surface comes into surface contact with the metallic foil (a collector) 700. Therefore, there is no gap between the contacting surface and the surface of the metallic foil 700, and electrode mixture paste X having high viscosity does not sufficiently spread over the contacting surface. Thus, the film thickness of the electrode mixture paste applied to the metallic foil 700 will become non-uniform.

On the other hand, in the plate 600 shown in FIG. 8, the contacting surface comes into point contact with the metallic foil 700. Therefore, there are moderate gaps between the contacting surface and the metallic foil 700, and the electrode mixture paste X having high viscosity sufficiently spreads over the contacting surface. Thus, the electrode mixture paste can be applied to the metallic foil 700 with a uniform film thickness.

Note that the present invention is not limited to the above-described embodiments, and modifications can be made as appropriate without departing from the scope thereof.

The present application claims priority rights of and is based on Japanese Patent Application No. 2013-242173 filed on Nov. 22, 2013 in the Japanese Patent Office, the entire contents of which are hereby incorporated by reference.

### INDUSTRIAL APPLICABILITY

It is possible to provide a rotary screen plate that can apply electrode mixture paste on a collector with a uniform film thickness and a method of manufacturing a secondary battery.

### REFERENCE SIGNS LIST

1 Outer Peripheral Surface
11 Injection Hole
12 Projection
100 Rotary Screen Plate
200 Electroformed Mold
201 Groove
300 Mesh

1. A rotary screen plate that is a cylindrical body including, in an outer peripheral surface of the cylindrical body, a plurality of injection holes through which printing paste is injected to a printed substrate from inside the cylindrical body, the rotary screen plate being electroformed, the rotary screen plate comprising:
a projection that projects outwardly of the cylindrical body further than another part of the outer peripheral surface on the outer peripheral surface of the cylindrical body, wherein
the rotary screen plate is a mesh having a shape of the cylindrical body, and
when the projection is formed at an intersection of wires constituting the mesh, a gap is formed between a part other than the intersection and the outer peripheral surface of the rotary screen plate.

2. A rotary screen plate that is a cylindrical body including, in an outer peripheral surface of the cylindrical body, a plurality of injection holes through which electrode mixture paste is injected to a collector from inside the cylindrical body, the rotary screen plate being electroformed, the rotary screen plate comprising:
a projection that projects outwardly of the cylindrical body further than another part of the outer peripheral surface on the outer peripheral surface of the cylindrical body, wherein
the rotary screen plate is a mesh having a shape of the cylindrical body, and
when the projection is formed at an intersection of wires constituting the mesh, a gap is formed between a part other than the intersection and the outer peripheral surface of the rotary screen plate.

3. The rotary screen plate according to claim 1, wherein the outer peripheral surface of the rotary screen plate comes into point contact with the printed substrate.

4. The rotary screen plate according to claim 2, wherein the outer peripheral surface of the rotary screen plate comes into point contact with the collector.

5. A method of manufacturing a secondary battery comprising:
a step for applying electrode mixture paste to a collector using the rotary screen plate according to claim 2.
